(19) United States
(12) Patent Application Publication
(10) Pub. No.: US 2026/0044244 A1
(43) Pub. Date: Feb. 12, 2026

(54) COMPUTING DEVICE AND METHOD FOR DISPLAYING WIDGET CONTENT WITH VISUAL EFFECT

(71) Applicant: Lemon Inc., Grand Cayman (KY)

(72) Inventors: Ryan Northway, Culver City, CA (US); Long Jiang, Culver City, CA (US)

(21) Appl. No.: 18/798,666

(22) Filed: Aug. 8, 2024

(51) Int. Cl. G06F 3/04817; G06Q 50/00

(52) U.S. Cl. CPC G06F 3/04817; G06Q 10/40

(57) ABSTRACT

A computing device is provided, including processing circuitry and memory storing instructions that, during execution, cause the processing circuitry to cause a widget to be displayed on a home screen graphical user interface (GUI) of an operating system of the computing device. The processing circuitry is further configured to send a request for widget content to a widget content application programming interface API of an effects server of a social media platform. The widget content includes an image of a visual effect available at the effects server that is configured to be applied to user generated content that can be posted on the social medial platform. The processing circuitry is further configured to receive the widget content from the widget content API of the effects server. The processing circuitry is further configured to display the widget content in the widget on the home screen GUI.

### BACKGROUND

Social media platforms provide tools for users to add effects to images and videos before publishing content online. Some of these effects are applied over human faces, such as filters, stickers, and textures designed to make it appear as though objects or materials are present in the images and videos, when they actually are not, or otherwise alter or augment real world objects. These effects are typically provided in a library of effects. Some social media platforms allow users to create new effects themselves, and large numbers of new effects are continually being created by users. However, due to the sheer volume of newly generated creative effects made available by users, identifying effects that align with individual user preferences poses a significant challenge.

### SUMMARY

A computing device is provided herein. In one example, the computing device includes processing circuitry and memory storing instructions that, during execution, cause the processing circuitry to cause a widget to be displayed on a home screen graphical user interface (GUI) of an operating system of the computing device. The processing circuitry is further configured to send a request for widget content to a widget content application programming interface API of an effects server of a social media platform. The widget content includes an image of a visual effect available at the effects server that is configured to be applied to user generated content that can be posted on the social medial platform. The processing circuitry is further configured to receive the widget content from the widget content API of the effects server. The processing circuitry is further configured to display the widget content in the widget on the home screen GUI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a client computing device and effects server of a social media platform.

FIG. 2 shows an example home screen graphical user interface (GUI) of the computing device of FIG. 1, displaying a widget along with application icons.

FIG. 3 shows an example home screen GUI of the computing device of FIG. 1, displaying a widget content including an image of a visual effect.

FIG. 4 shows an example home screen GUI of the computing device of FIG. 1, displaying the widget content including an individual image with the visual effect.

FIG. 5 shows an example home screen GUI of the computing device of FIG. 1, displaying the widget content including a live front-facing camera image with the visual effect.

FIG. 6 shows a flowchart of a computerized method for displaying the widget content including an image of a visual effect according to the present disclosure.

FIG. 7 shows a schematic view of an example computing environment in which the computing device and effects server of FIG. 1 may be enacted.

### DETAILED DESCRIPTION

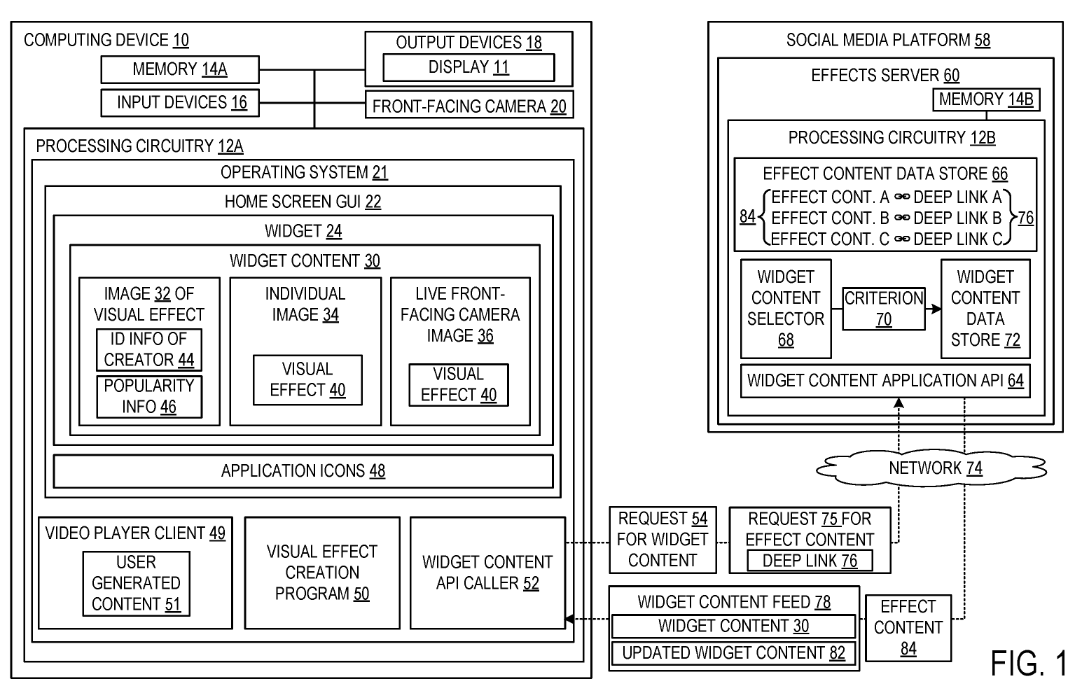

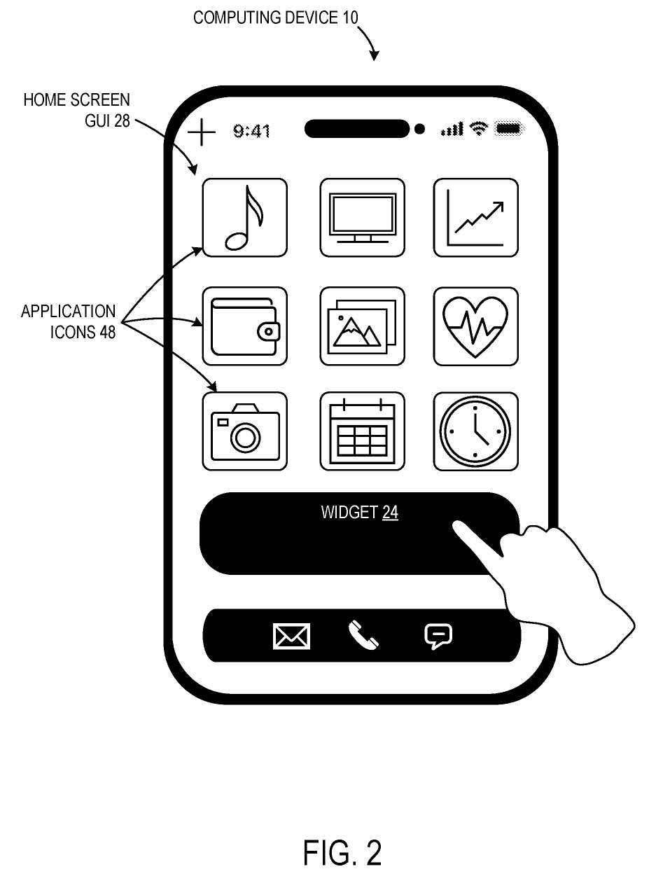

To address the issues described above, FIG. 1 illustrates a computing device 10 for displaying widget content 30 including an image 32 of a visual effect. The computing device 10 serves as a client device, and computing device 10 could be a device such as a smartphone, tablet, smartwatch, or personal computer, for example. The computing device 10 comprises processing circuitry 12A, memory 14A, one or more input devices 16 for receiving user input, output devices 18 such as a display 11, and front-facing camera 20. The memory 14A stores instructions that, when executed by the processing circuitry 12A, cause the processing circuitry 12A to cause a widget 24 to be displayed on a home screen graphical user interface (GUI) 22 of an operating system 21 of the computing device 10. Briefly turning to FIG. 2, this figure shows an example home screen GUI 22 of the computing device 10 of FIG. 1, displaying the widget 24 along with application icons 48. The widget 24 on the home screen GUI 22 provides timely information from user’s favorite applications at a glance, including today’s headlines, weather, stocks, calendars and etc., without having to launch the application. For example, as shown in FIG. 2, the widget 24 can be created by touching and holding an empty area on the home screen GUI 22 and tapping the “+” button on the top-left corner of the screen. Additionally, users have the flexibility to choose from various sizes for the widget 24.

Turning back to FIG. 1, the processing circuitry 12A is configured to send, via a widget content API caller 52, a request 54 for the widget content 30 to a widget content application programming interface API 64 of an effects server 60 of a social media platform 58 via a computing network 74. The effects server 60 and the client computing device 10 may be in communication with one another via the computing network 74 and the widget content API 64. The widget content 30 includes the image 32 of the visual effect that is configured to be applied to user generated content 51 that can be posted on the social medial platform 58 and downloaded via a video player client 49 of the computing device 10. The image 32 of the visual effect may be a frame in a video that plays in the widget 24 on the home screen GUI 22, where the image 32 of the visual effect may be a static still image, a dynamic moving video, or other types of media. The social media platform 58 may be a user video-sharing platform that can be accessed by the video player client 49 on the computing device 10. The video player client 49 may be a user video-sharing application configured to create and play the user generated contents 51 (videos) in a video feed. The user generated contents 51 (videos) in the video feed may be short-form videos that have durations ranging from 15 seconds to 3 minutes. Videos of other durations may also be used.

The effects server 60 of the social media platform 58 comprises processing circuitry 12B and memory 14B storing instructions that, during execution, cause the processing circuitry 12B to instantiate the widget content application programming interface (API) 64. The widget content API 64 enables users to build interactive and customizable widgets 24. The processing circuitry 12B of the effects server 60 receives the request 54 for widget content via the widget content API 64 from the client computing device 10, as mentioned above. The processing circuitry 12B of the effects server 60 is further configured to select, via a widget content selector 68, the widget content 30 from a widget content data store 72 based on a predetermined criterion 70. The predetermined criterion 70 may be selected from the group consisting of popularity, recency, and usage frequency. At least one of these criterion is typically used, and it is possible for a plurality of these criteria to be used in combination for selection of widget content 30. For instance, if the visual effects of the widget content 30 have been widely used and positively received by users, the visual effects of the widget content 30 are prioritized based on popularity. If the visual effects of the widget content 30 have been recently posted on the social media platform 58 and positively received by users, the visual effects of the widget content 30 are prioritized based on recency. If the visual effects of the widget content 30 have been frequently used by users during a certain recent period (e.g., during the last 30 days), the visual effects of the widget content 30 are prioritized based on frequency. It will be appreciated that another criterion 70 can be utilized for widget content selection. For example, the widget content 30 can be selected based on a specific content creator or a user’s location, where the widget content 30 which is popular in the user’s country or region is selected. Furthermore, a plurality of such criteria 70 may be used in combination for widget content selection. Upon selecting the widget content 30, the processing circuitry 12B of the effects server 60 is further configured to transmit, via the widget content API 64, the selected widget content 30 in a widget content feed 78 to the client computing device 10 to be displayed on the home screen GUI 22 of the operating system 21 of the client computing device 10. The processing circuitry 12B of the effects server 60 is further configured to transmit an updated widget content 82 in the widget content feed 78 to the computing device 10 periodically.

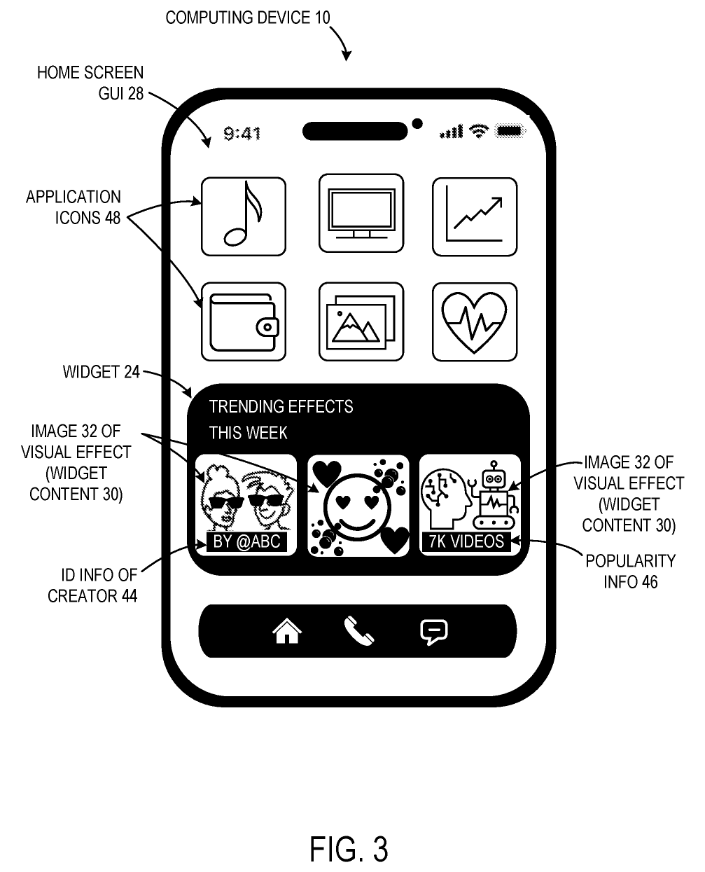

The processing circuitry 12A of the client computing device 10 is configured to receive, via the widget content API caller 52, the widget content 30 from the widget content API 64 of the effects server 60 and display the widget content 30 in the widget 24 on the home screen GUI 22. The processing circuitry 12A is further configured to refresh the widget content 30 periodically, with the updated widget content 82 from the widget content feed 78 from the widget content API 64 of the effects server 60. As described above, the widget content 30 includes the image 32 of the visual effect. Further, the widget content 30 may include an identification information of a creator 44 of the visual effect and/or popularity information 46 of the visual effect over the image 32 of the visual effect. Additionally, the widget content 30 may include an individual image 34 where a visual effect 40 is applied. Moreover, the widget content 30 may include a live front-facing camera image 36 of a user where the visual effect 40 is applied. Briefly turning to FIG. 3, this figure shows an example home screen GUI 28 of the computing device 10 of FIG. 1, displaying the widget content 30 including the image 32 of the visual effect. In the depicted example, three widget contents 30 with three different types of the visual effects are displayed as trending effects this week in the widget 24. These widget contents 30 are selected based on frequency, where the top three most used visual effects this week are chosen. Furthermore, as shown in FIG. 3, the creator information “BY @ABC” and popularity information “7K VIDEOS” are displayed over the images 32 of the visual effects of the widget contents 30. It will be appreciated that other information on the widget content 30 such as creation date can be displayed over the image 32 of the visual effect.

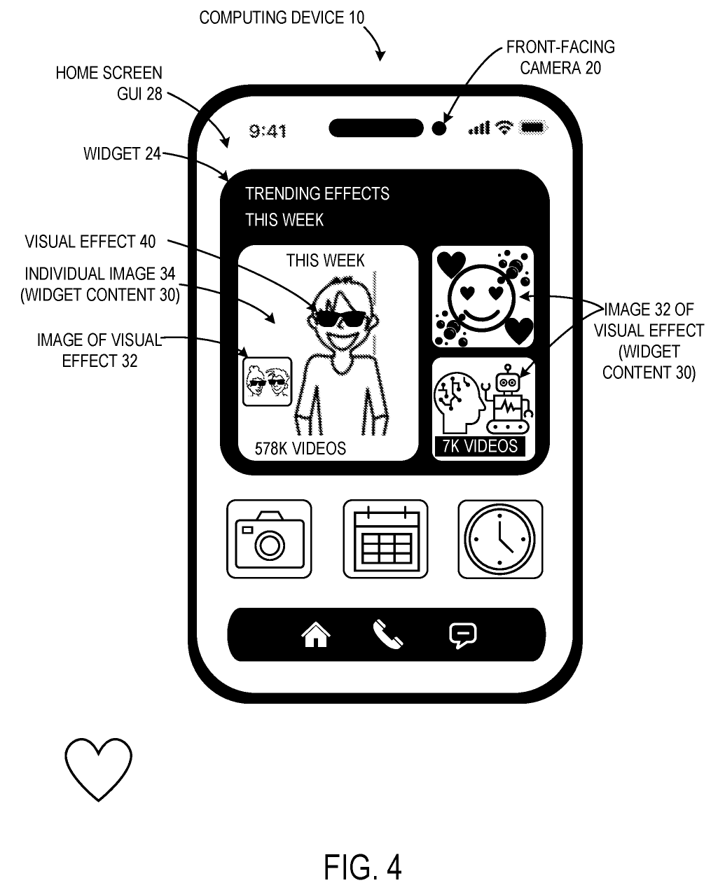

Briefly turning to FIG. 4, this figure shows an example home screen GUI 22 of the computing device 10 of FIG. 1, displaying the widget content 30 including the individual image 34 with the visual effect 40. As shown in the depicted example, the individual image 34 with the visual effect 40 (e.g., sunglasses) as well as the images 32 of the visual effects are displayed in the widget 24. As shown in the figure, the image 32 of visual effect which corresponds to the applied visual effect 40 (e.g., sunglasses) may be displayed over the individual image 34. Furthermore, the creator information, popularity information, and other information may be displayed over the individual image 34.

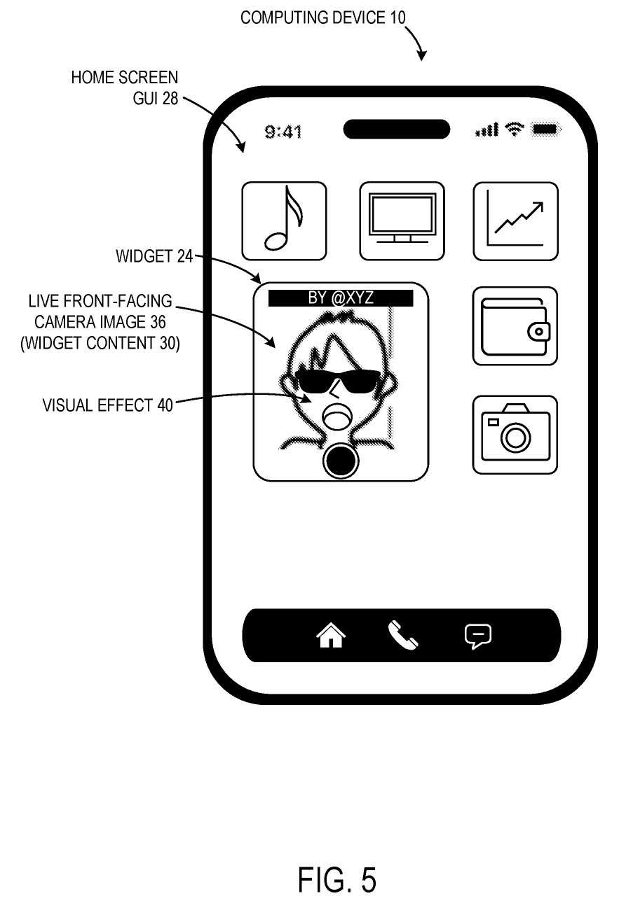

Briefly turning to FIG. 5, this figure shows an example home screen GUI 28 of the computing device 10 of FIG. 1, displaying the widget content 30 including the live front-facing camera image 36 with the visual effect 40. As shown in the depicted example, the live front-facing camera image 36 with the visual effect 40 (e.g., funny-looking face), captured by the front-facing camera 20 of the computing device 10, is displayed in the widget 24. It will be appreciated that the image 32 of visual effect which corresponds to the applied visual effect 40 (e.g., funny-looking face) may be displayed over the live front-facing camera image 36. Furthermore, the creator information (e.g., “BY @XYZ”), popularity information, and other information may be displayed over the live front-facing camera image 36.

Turning back to FIG. 1, the widget content 30, including the image 32 of the visual effect or the individual image 34, is linked to a visual effect creation program 50 in the computing device 10. The visual effect creation program 50 allows creators to design and develop augmented effects for the social media platform 58. With the visual effect creation program 50, users can easily create, publish, and share high-quality visual effects on the social media platform 58. When the widget content 30 is tapped by a user, the processing circuitry 12A is configured to launch the visual effect creation program 50, where the corresponding visual effects of the widget content 30 are ready to be applied in the visual effect creation program 50, as discussed in detail below. The widget content 30 is linked to effect content 84 of the visual effect creation program 50 via a deep link 76 at least partially hosted by the effects server 60. In response to the widget content 30 being tapped by a user, a request for effect content 75 including the deep link 76 is generated by the client computing device 10 and transmitted to the effects server 60. The effects server 60, upon receiving the request for effect content 75, is configured to locate the effect content stored in an effect content data store 66 using the deep link 76, and serve the effect content 84 related to the widget content 30 to the computing device 10. In the user generated content data store 66, each of the effect contents 84 (A, B, C) is linked to its corresponding deep link 76 (A, B, C) for retrieval. As a result, the effect content 84 is available for use in the visual effect creation program 50 of the computing device 10. It will be appreciated that a deeplink is a link to specific content within a hosted site (such as a website), and thus includes not only a network address but also a path and or parameters that indicate specific content within the site.

Furthermore, when the widget content 30 includes the live front-facing camera image 36, the widget content 30 is linked to the front-facing camera 20 of the computing device 10. When the widget content 30 is tapped by a user, the live front-facing camera image 36 of the user, with the image of the visual effect, with the visual effect 40, is displayed. It will be appreciated that the widget content may be linked to other programs or functions of the social media platform 58, such as videos in the video feed, using the corresponding visual effects.

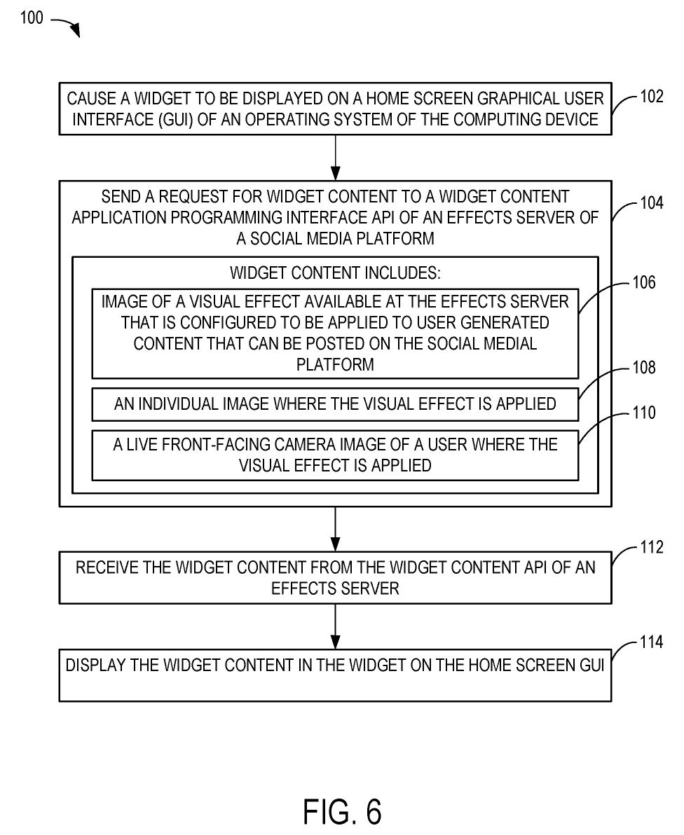

FIG. 6 shows a flowchart of a computerized method 100 for displaying the widget content including the image of the visual effect according to the present disclosure. The method 100 may be implemented by the computing system 10 illustrated in FIG. 1. At 102, the method 100 may include causing a widget to be displayed on a home screen graphical user interface (GUI) of an operating system of the computing device. At 104, the method 100 may include sending a request for widget content to a widget content application programming interface API of an effects server of a social media platform. The widget content may include an image of a visual effect available at the effects server that is configured to be applied to user generated content that can be posted on the social medial platform (see 106). The widget content may further include an individual image where the visual effect is applied (see 108). The widget content may further include a live front-facing camera image of a user where the visual effect is applied. (see 110). At 112, the method 100 may further include receiving the widget content from the widget content API of an effects server. At 114, the method 100 may further include displaying the widget content in the widget on the home screen GUI.

The above computing device and method can effectively share trending visual effects on social media platforms using widgets. By doing so, users become aware of the most popular visual effects and/or most trending visual effects that can complement their videos. These enhancements significantly boost user engagement and overall satisfaction. Moreover, this innovative approach allows effect content creators and users to seamlessly integrate these trending effects into their short-form videos. Additionally, the widget-based delivery ensures that users stay informed about the latest visual effects without having to actively search for them or launch a client program.

In some embodiments, the methods and processes described herein may be tied to a computing system of one or more computing devices. In particular, such methods and processes may be implemented as a computer-application program or service, an application-programming interface (API), a library, and/or other computer-program product.

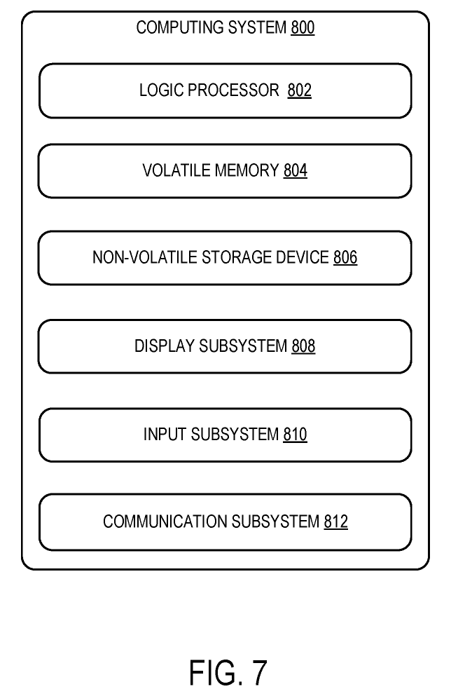

FIG. 7 schematically shows a non-limiting embodiment of a computing device 10 or effects server 60 that can enact one or more of the methods and processes described above. Computing system 200 is shown in simplified form. Computing system 200 may embody the computing device 10 or effects server 60 described above and illustrated in FIG. 1. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 7.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

The following paragraphs provide additional description of the subject matter of the present disclosure. One aspect provides a computing device comprising processing circuitry and memory storing instructions that, during execution, cause the processing circuitry to cause a widget to be displayed on a home screen graphical user interface (GUI) of an operating system of the computing device. The processing circuitry is further configured to send a request for widget content to a widget content application programming interface API of an effects server of a social media platform, the widget content including an image of a visual effect available at the effects server that is configured to be applied to user generated content that can be posted on the social medial platform. The processing circuitry is further configured to receive the widget content from the widget content API of the effects server. The processing circuitry is further configured to display the widget content in the widget on the home screen GUI.

In this aspect the widget content is linked to a visual effect creation program, and when the widget content is tapped by a user, the processing circuitry is configured to launch the visual effect creation program.

In this aspect, the processing circuitry is further configured to refresh the widget content periodically, with updated widget content from a widget content feed from the widget content API of the effects server.

In this aspect, the widget content is selected by the effects server based on at least one criterion selected from the group consisting of popularity, recency, and usage frequency.

In this aspect, the widget content includes an individual image where the visual effect is applied.

In this aspect, the widget content includes a live front-facing camera image of a user where the visual effect is applied.

In this aspect, the widget content is linked to a front-facing camera of the computing device, and when the widget content is tapped by a user, a live front-facing camera image of the user, with the visual effect, is displayed.

In this aspect, the widget content displays identification information of a creator of the widget content over the image of the visual effect.

In this aspect, the widget content displays popularity information of the widget content over the image of the visual effect.

In this aspect, the user generated content includes a short-form video that has a duration ranging from 15 seconds to 3 minutes.

In this aspect, the image of the visual effect is a frame in a video that plays in the widget on the home screen GUI.

Another aspect provides a computerized method comprising causing a widget to be displayed on a home screen graphical user interface (GUI) of an operating system of the computing device, sending a request for widget content to a widget content application programming interface API of an effects server of a social media platform, the widget content including an image of a visual effect available at the effects server that is configured to be applied to user generated content that can be posted on the social medial platform, receiving the widget content from the widget content API of an effects server; and displaying the widget content in the widget on the home screen GUI.

In this aspect, the widget content is selected by the effects server based on at least one criterion selected from the group consisting of popularity, recency, and usage frequency.

In this aspect, the widget content includes an individual image where the visual effect is applied.

In this aspect, the widget content includes a live front-facing camera image of a user where the visual effect is applied.

In this aspect, the widget content displays identification information of a creator of the widget content over the image.

In this aspect, the image is a frame in a video that plays in the widget on the home screen GUI.

Another aspect provides an effects server comprising processing circuitry and memory storing instructions that, during execution, cause the processing circuitry to instantiate a widget content application programming interface (API). The processing circuitry is further configured to receive a request via the widget content API for widget content from a client device, the widget content including an image of a visual effect that is configured to be applied to user generated content that can be posted on a social medial platform. The processing circuitry is further configured to select the widget content based on a predetermined criterion. The processing circuitry is further configured to transmit, via the widget content API, the selected widget content to the client device to be displayed on a home screen graphical user interface (GUI) of an operating system of the client device.

In this aspect, the widget content is linked to effect content of a visual effect creation program via a deep link at least partially hosted at the effects server, and in response to the widget content being tapped by a user, a request for effect content is generated by the client computing device and transmitted to the effects server, and the effects server, upon receiving the request for effect content, is configured to locate the effect content using the deep link, and serve the effect content related to the widget content.

In this aspect, the predetermined criterion is selected from the group consisting of popularity, recency, and usage frequency.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
processing circuitry and memory storing instructions that, during execution, cause the processing circuitry to:
cause a widget to be displayed on a home screen graphical user interface (GUI) of an operating system of the computing device;
send a request for widget content to a widget content application programming interface API of an effects server of a social media platform, the widget content including an image of a visual effect available at the effects server that is configured to be applied to user generated content that can be posted on the social medial platform;
receive the widget content from the widget content API of the effects server; and
display the widget content in the widget on the home screen GUI.

2. The computing device of claim 1, wherein
the widget content is linked to a visual effect creation program, and
when the widget content is tapped by a user, the processing circuitry is configured to launch the visual effect creation program.

3. The computing device of claim 1, wherein
the processing circuitry is further configured to refresh the widget content periodically, with updated widget content from a widget content feed from the widget content API of the effects server.

4. The computing device of claim 1, wherein
the widget content is selected by the effects server based on at least one criterion selected from the group consisting of popularity, recency, and usage frequency.

5. The computing device of claim 1, wherein
the widget content includes an individual image where the visual effect is applied.

6. The computing device of claim 1, wherein
the widget content includes a live front-facing camera image of a user where the visual effect is applied.

7. The computing device of claim 6, wherein
the widget content is linked to a front-facing camera of the computing device, and
when the widget content is tapped by a user, a live front-facing camera image of the user, with the visual effect, is displayed.

8. The computing device of claim 1, wherein
the widget content displays identification information of a creator of the widget content over the image of the visual effect.

9. The computing device of claim 1, wherein
the widget content displays popularity information of the widget content over the image of the visual effect.

10. The computing device of claim 1, wherein
the user generated content includes a short-form video that has a duration ranging from 15 seconds to 3 minutes.

11. The computing device of claim 1, wherein
the image of the visual effect is a frame in a video that plays in the widget on the home screen GUI.

12. A computerized method, comprising:
causing a widget to be displayed on a home screen graphical user interface (GUI) of an operating system of the computing device;
sending a request for widget content to a widget content application programming interface API of an effects server of a social media platform, the widget content including an image of a visual effect available at the effects server that is configured to be applied to user generated content that can be posted on the social medial platform;
receiving the widget content from the widget content API of an effects server; and
displaying the widget content in the widget on the home screen GUI.

13. The computerized method of claim 12, wherein
the widget content is selected by the effects server based on at least one criterion selected from the group consisting of popularity, recency, and usage frequency.

14. The computerized method of claim 12, wherein
the widget content includes an individual image where the visual effect is applied.

15. The computerized method of claim 12, wherein
the widget content includes a live front-facing camera image of a user where the visual effect is applied.

16. The computerized method of claim 12, wherein
the widget content displays identification information of a creator of the widget content over the image.

17. The computerized method of claim 12, wherein
the image is a frame in a video that plays in the widget on the home screen GUI.

18. An effects server, comprising:
processing circuitry and memory storing instructions that, during execution, cause the processing circuitry to:
instantiate a widget content application programming interface (API);
receive a request via the widget content API for widget content from a client device, the widget content including an image of a visual effect that is configured to be applied to user generated content that can be posted on a social medial platform;
select the widget content based on a predetermined criterion; and
transmit, via the widget content API, the selected widget content to the client device to be displayed on a home screen graphical user interface (GUI) of an operating system of the client device.

19. The effects server of claim 18, wherein
the widget content is linked to effect content of a visual effect creation program via a deep link at least partially hosted at the effects server, and
in response to the widget content being tapped by a user, a request for effect content is generated by the client computing device and transmitted to the effects server, and the effects server, upon receiving the request for effect content, is configured to locate the effect content using the deep link, and serve the effect content related to the widget content.

20. The effects server of claim 18, wherein
the predetermined criterion is selected from the group consisting of popularity, recency, and usage frequency.
